(19) United States
(12) Patent Application Publication
(10) Pub. No.: US 2006/0127865 A1
(43) Pub. Date: Jun. 15, 2006

(54) Integrated watchstation training system

(75) Inventors: Clementina Maria Siders, Orlando, FL (US); Douglas Joseph Samuel, Davenport, FL (US); Scott Burlingame, Longwood, FL (US)

Correspondence Address: NAVAL AIR WARFARE CENTER TRAINING SYSTEMS DIVISION, 12350 RESEARCH PARKWAY, TSD 773P, ORLANDO, FL, 32826-3275, US

(73) Assignee: Government of the United States as represented by the Secretary of the Navy

(21) Appl. No.: 11/013,463

(22) Filed: Dec. 13, 2004

(51) Int. Cl. G09B 19/00

(52) U.S. Cl. 434/219

(57) ABSTRACT

An exemplary embodiment of the invention relates to training employees to perform tasks of a defined watchstation. Based on performance analysis, training materials are displayed on a portable personal computer. A performance guide is used in addition to the tablet personal computer for on the job instruction. A personal computer is also used to manage training of the employees by providing testing, tracking, control and feedback. In addition, a computer provides management of the training program.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE OR A COMPUTER PROGRAM

### LISTING APPENDIX SUBMITTED ON A COMPACT DISC

Not Applicable

### BACKGROUND OF THE INVENTION

1. Field of the Invention

This invention relates to the field of training and more particularly to job qualification training.

2. Description of the Related Art

Job qualification training is a unique art within the broad discipline of training. Qualification training is typically associated with a specific job encompassing a specific set of performance requirements. In a shipboard environment, jobs with associated qualification training are known as watchstations, and employees assigned to watchstations are known as watchstanders. The key attribute of jobs or watchstations associated with qualification training is that the employee (or watchstander) cannot perform the specified job until he or she has completed the qualification-training program and is formally certified (usually in writing) by a supervisor as qualified to perform that job.

Jobs associated with qualification training encompass a variety of functions and can be defined to encompass an entire section of a facility, such as a control room or a machinery space. The job can encompass a rather large area, where the employee is required to provide hands-on operation of systems and equipment such as valves and local controls, or the job can provide for remote operation of systems and equipment. Job performance requirements can also involve the supervision of a subordinate within the team.

Qualification training applies to jobs in a variety of settings especially where there is a need for continuous monitoring and immediate response. For example, qualification training is conducted at facilities for the petrochemical, power generation, marine, and other industrial facilities, especially facilities that effect physical transformations. For example, and not by way of limitation, qualification training or more specifically watchstation training is conducted aboard ships, such as United States Navy ships to monitor and operate on-board systems such as power generation systems, electrical distribution systems, propulsion systems, navigation systems, weapons systems, hydraulic systems, plumbing systems, distillation systems and so on. Often the systems have associated subsystems, and these subsystems may comprise of a subordinate watchstation within a watch team. As can be appreciated, these complex watchstations require comprehensive and standardized qualification training.

Qualification training is generally accomplished through the integration of individual self-paced training and on-the-job training integrated through various levels of operator proficiency.

Satisfactory operation of actual equipment and systems is integrated into the operator trainee's on-the-job instruction. (As used hereinbelow the term “operator” and “watchstander” are used interchangeably.) The majority of the trainee's on-the-job training will be completed once the operator trainee has been assigned to his ship. When assigned to a ship the operator trainee will complete qualification training by mastering the performance requirements of a particular watchstation and understanding the fundamental knowledge supporting each performance. As is well known in the art, the operator trainee is often provided a “qualification guide” to identify the performance objectives of the watchstation. The operator trainee will then seek qualified personnel who will teach the operator trainee the required material and then “check out” the operator trainee. Usually the final “check out” is an oral examination that encompasses the integrated operation of the watchstation. Upon successful completion of all the “check outs” for the watchstation, the operator trainee will be formally certified in writing as “qualified” to perform the job requirements of the watchstation without mentoring.

It is to be noted that the “objectives” that the operator trainee learns to accomplish have been preselected to focus his or her learning upon the attributes and characteristics of the equipment that are important to successful performance and include the integrated operation of several systems. Such objectives typically include normal and casualty operations. The science of determining and teaching the objectives is known as instructional system design (hereafter ISD).

The shipboard portion of the qualification process must be repeated each and every time an operator transfers to a new ship because no two ships have identical configurations or operating parameters. Similarly, variations in equipment, systems and their associated configurations typically exist within the product lines of industrial facilities. For example, nuclear reactor power plants vary among the different ships in the U.S. Navy, and commercial nuclear reactor systems vary at different commercial sites. Therefore, experienced operators throughout industry are in continual need of qualification training.

By example and not by way of limitation, typical of the qualification training processes is the U.S. Coast Guard's qualification training. U.S. Coast Guard qualification training is accomplished through two aspects consisting of (1) the integration of self-study, and (2) hands-on instruction and evaluation provided by knowledgeable, experienced personnel.

Personnel Qualification Standards (hereinafter, “PQS”) are developed at the organizational level and administered locally (i.e., at fleet ships). In a locally administered watchstander qualification process such as the U.S. Coast Guard's qualification process, the self-study portion is based on PQS, when applicable. PQS is a checklist of predefined objectives that must be accomplished in order for a trainee to qualify for a particular watchstation or job. Organizational level PQS does not exist for many watchstations, or is too generic for direct application at individual field units. In these circumstances, each unit generates unique Job Qualification Requirements (hereinafter “JQR”) to document qualification objectives at the unit.

In practice, a trainee will read each objective and then research local material that resides aboard a ship to obtain the knowledge necessary to satisfy the objective. Information necessary to satisfy the PQS/JQR objectives is found among different reference materials, at the local level, that are not easily accessed because the materials reside in diverse sources such as design documents, operations and maintenance manuals, vendor technical manuals, and architect-engineering documents such as specifications and drawings. Furthermore, data within these sources often conflict among the sources, Therefore, the trainee must find the right document and further determine whether the trainee has found the right information to satisfy a generic objective. This training system results in inefficiency, gaps in critical knowledge, and variance in an individual's core level of fundamental knowledge.

The second aspect of PQS/JQR is hands-on (on-the-job) instruction provided by mentors and experienced personnel. The trainee follows and observes or “shadows” an experienced watchstander while the experienced watchstander explains the function and operation of equipment relevant to the watchstation or job. The explanation may be followed by a demonstration, or the trainee may undergo closely supervised performance.

This second aspect of PQS/JQR has many shortcomings. It is often very time-consuming, and frequently involves lengthy delays for coordination to complete training. The attentiveness and availability of the experienced watchstander or “mentor,” as well as trainee access to operational equipment and systems also adversely affects the outcome of this aspect of the qualification process. The quality of the instruction given to a trainee may also vary as a function of the technical expertise of the instructor. Finally, the ability of the mentor and the trainee to communicate is also a factor that affects quality.

Evaluation in the current qualification process is subjective as it is based on inconsistently applied review of PQS objectives and is documented only by the signature of a senior individual known as a “designated qualifier,” who orally tests the trainee to certify that the PQS objective was satisfied. The evaluation process results in a non-standard qualification system that is nearly impossible to document outside of the local training environment because the evaluation process lacks structured evaluation techniques.

One of the difficulties encountered when qualifying on a watchstation at a new facility is that qualification-training requirements are different. This difference results because local facilities generally develop training materials using their own staff to describe their unique local equipment. Over time, differences in philosophy also develop concerning the performance requirements of jobs or watchstations. For all of these reasons training qualification programs vary among different facilities.

Another difficulty is due to the requirement to keep a large number of watchstations manned while dealing with constant turnover of personnel. Sometimes dozens of different watchstations are present at a single facility. At the same time inexperienced personnel may be reporting in and experienced personnel departing. It is important to know which personnel are qualified, or are pursing qualification on a particular job or watchstation, especially when the facility is short-handed. Therefore, it is important to know the status of progress and rate of progress of all available personnel for any job or watchstation in order to know when personnel will be qualified.

Furthermore, it is important to predict how well a particular person is able to perform at the job or watchstation as well as to ascertain the benefit provided by the qualification training materials. In order to have confidence that the training program is producing competent watchstanders there is a need for systematic, standardized, knowledge and performance evaluation to validate competence as well as document progress.

Thus, there is a need for an integrated watchstation qualification system.

### BRIEF SUMMARY OF THE INVENTION

A method for qualifying a trainee includes performing a job task analysis. Digital, standardized training modules are developed after performing the job task analysis. Training modules are displayed on a personal computer for self paced training of the trainee. Questions are developed from the training modules and job performance requirements using accomplished performers. Then, questions are selected from a bank of questions whereby the selection is random. The questions are displayed on a personal computer for testing the trainee. Answers to the questions on the personal computer are graded and then analyzed for determining further training. Whether the trainee has mastered knowledge required to perform a job based upon the trainee's responses is determined. Standardized job task procedures defined by a performance guide are provided along with standard performance evaluation of the trainee by qualified supervisor.

A system for qualifying a trainee to perform in a clearly defined watchstation comprises a personal computer having training modules comprising instructional materials, a computer having administrative access for managing the training program and trainee access for testing on training material, and a performance guide for guiding the trainee through the performance requirements of the watchstation, the performance guide defining the procedures for job task performances.

A computer program for managing a watchstation qualification program that has multiple trainees and multiple watchstations comprises an execution program for registering each trainee, assigning each trainee to each watchstation, signing off each trainee for prerequisite certification, performing manual watch certification, creating data for each watchstation, editing data for each watchstation, clearing instructor flags for each trainee, generating qualification letters, submitting bugs, verifying test question integrity, checking the progress of each trainee, and predicting the time to qualification of each trainee. Multiple databases include a current user database, a performance task assignments database, a prerequisite assignments database, a qualification letter information database, a registration database, a setup information database, a test assignments database, a test database, a test responses database, a unit specific test parameters database, a watchstation assignments database, a watchstation catalog database, a watchstation list database, a watchstation performance tasks database and a watchstation prerequisites database. The execution program accesses each of the multiple databases to perform functions of the execution program.

It is an object of the present invention to provide standardized qualification materials.

It is another object of the present invention to provide structured testing to evaluate knowledge that directly supports job performance.

It is yet another object of the present invention to standardize evaluation of job task performance.

It is an additional objective of the present invention to track trainee progress and administer the qualification process.

These and other features and advantages of the present invention may be better understood by considering the following detailed description of certain preferred embodiments. In the course of this description, reference will frequently be made to the attached drawings.

### BRIEF DESCRIPTION OF THE SEVERAL VIEWS OF THE DRAWING

Referring now to the drawing wherein like elements are numbered alike in the several FIGURES:

FIG. 1 is a relationship diagram of the exemplary Watchstation Qualification System of the present invention;

FIG. 2 is a view of a typical tablet personal computer;

FIG. 3 is a screen capture of a typical training module page;

FIG. 4 is a flowchart showing an exemplary Watchstation Qualification Process of the present invention;

FIG. 5A is a flowchart showing the functional relationships of the exemplary WTT software of the present invention;

FIGS. 5B,C, D & E are class diagrams for the WTT software of the present invention;

FIG. 6 is a view of the WTT Login Screen as it appears on a personal computer screen;

FIG. 7 is a view of the WTT New User Registration Screen as it appears on a personal computer screen;

FIG. 8 is a view of the WTT Editing User Data Screen as it appears on a personal computer screen;

FIG. 9 is a view of the WTT Assigning Watchstation Screen as it appears on a personal computer screen;

FIG. 10 is a view of the WTT Add New Watchstation Screen as it appears on a personal computer screen;

FIG. 11 is a view of the WTT Edit Watchstation Data Screen as it appears on a personal computer screen;

FIG. 12 is a view of the WTT Administrative Certification Screen as it appears on a personal computer screen;

FIG. 13 is a view of the WTT Test Question History Screen as it appears on a personal computer screen;

FIG. 14 is a view of the WTT Student Menu as it appears on a personal computer screen;

FIG. 15 is a view of the WTT Test Selection Form as it appears on a personal computer screen;

FIG. 16A is a view of the WTT Test Screen as it appears on a personal computer screen;

FIG. 16B is a view of the WTT Bug Issue Report Screen as it appears on a personal computer screen;

FIG. 17 is a view of the View Signoff Screen as it appears on a personal computer screen; and

FIG. 18 is a view of the View Unit Test Status Screen as it appears on a personal computer screen.

### DETAILED DESCRIPTION OF THE INVENTION

Watchstation Qualification System

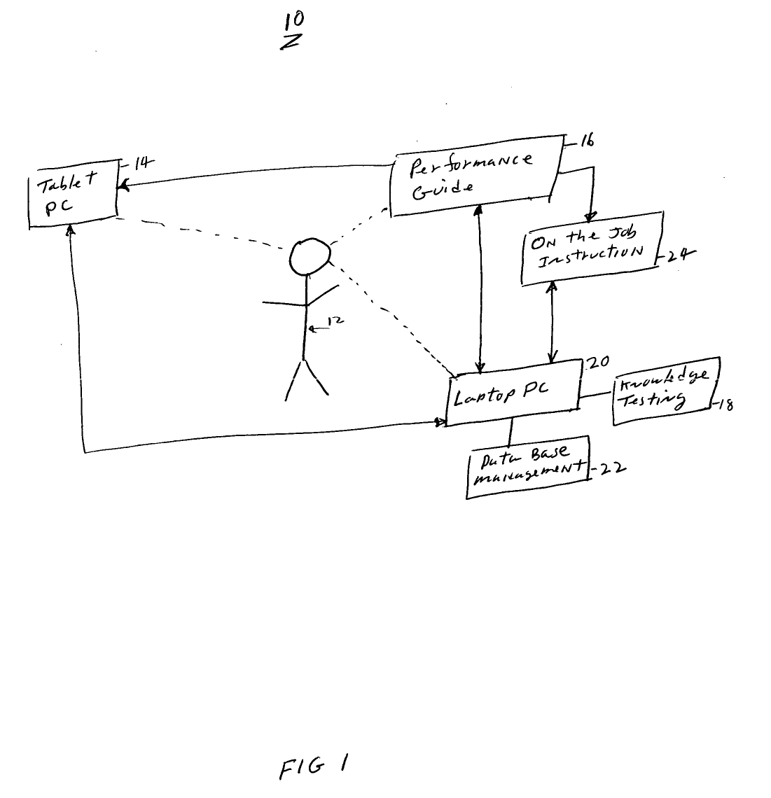

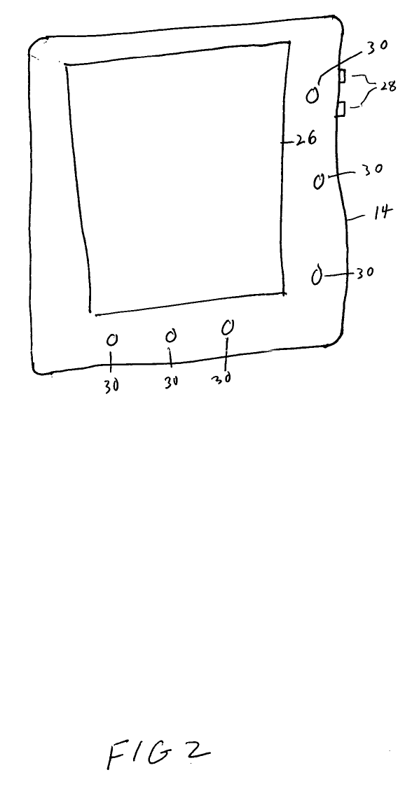

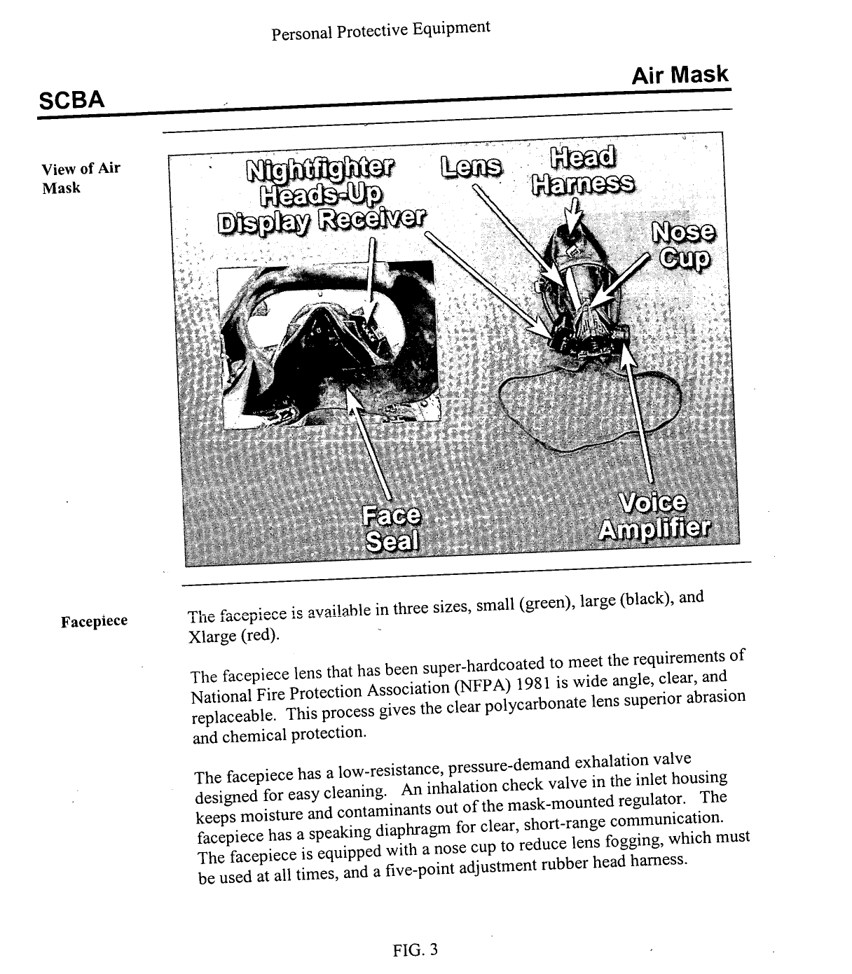

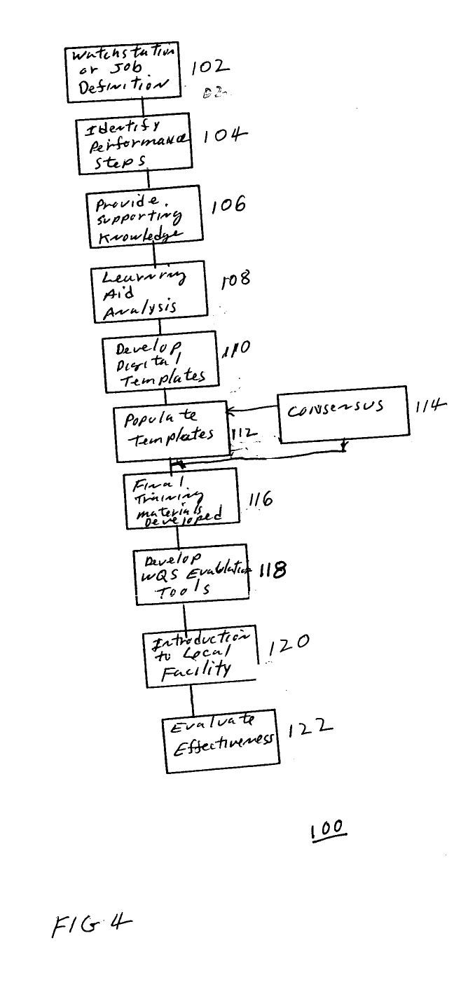

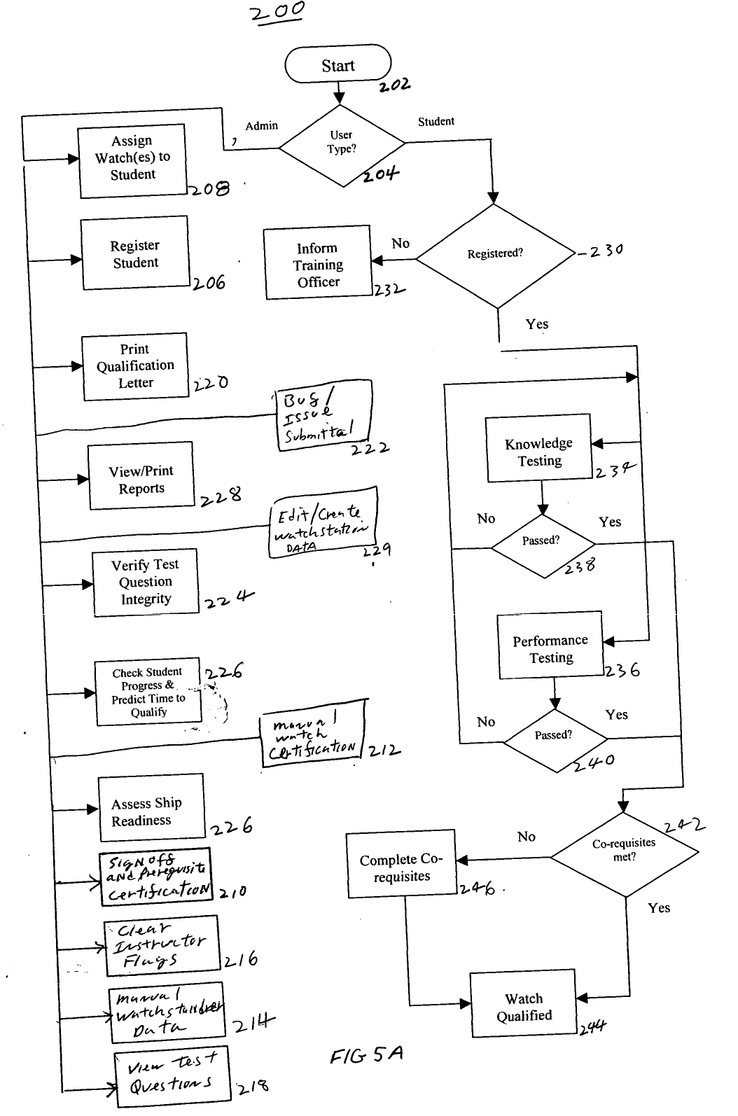

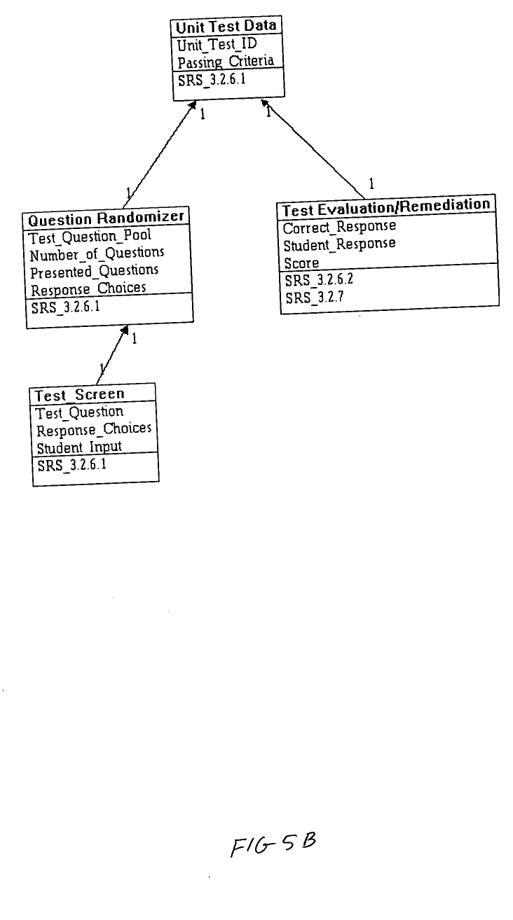

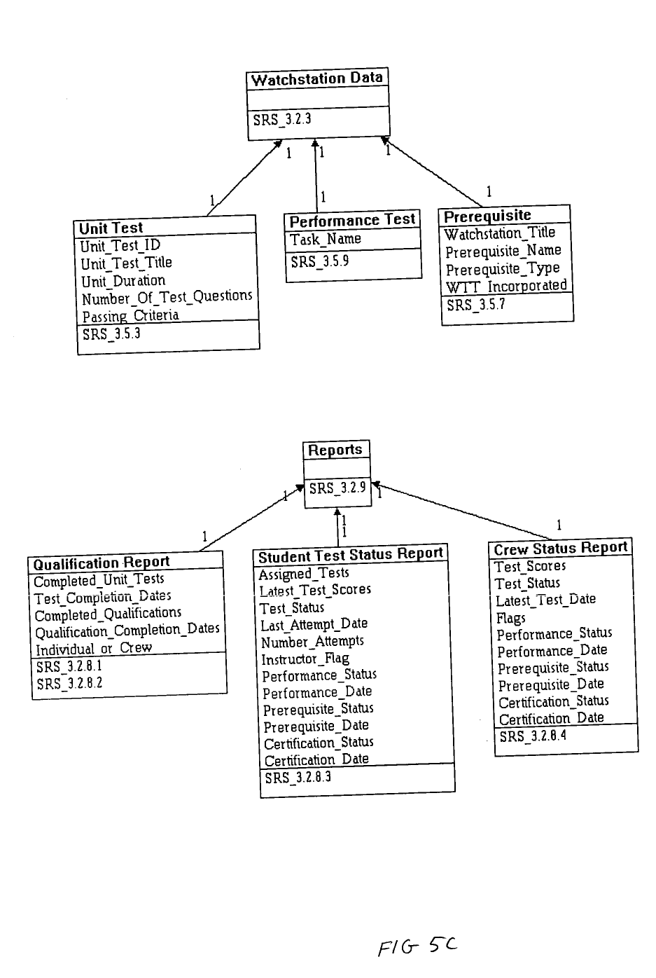

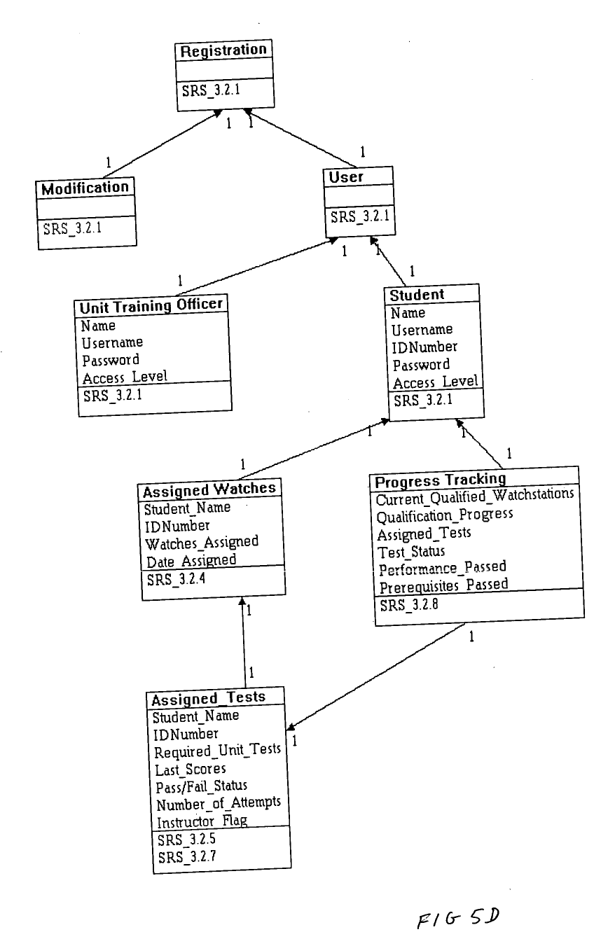

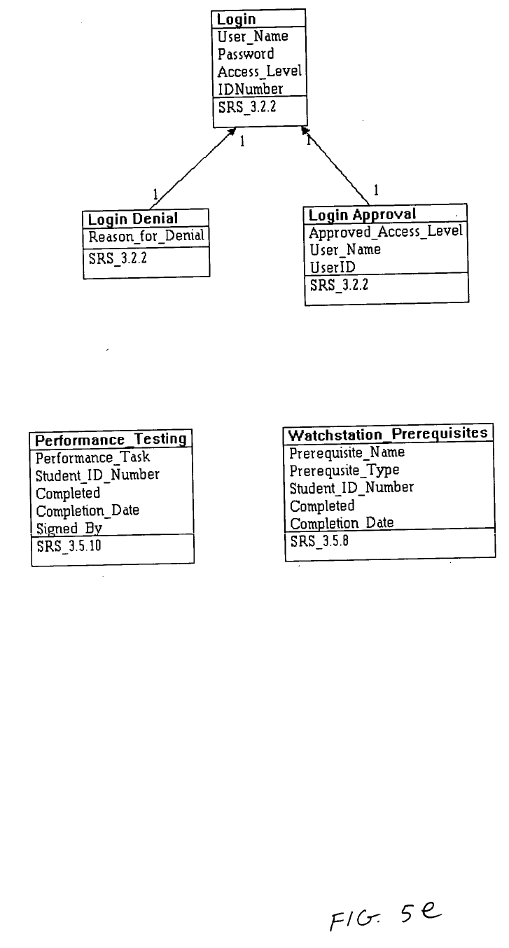

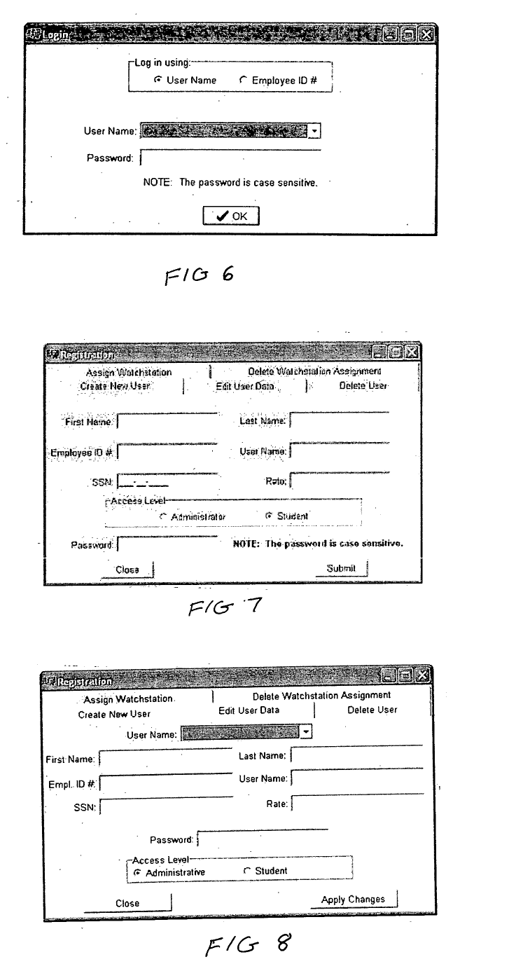

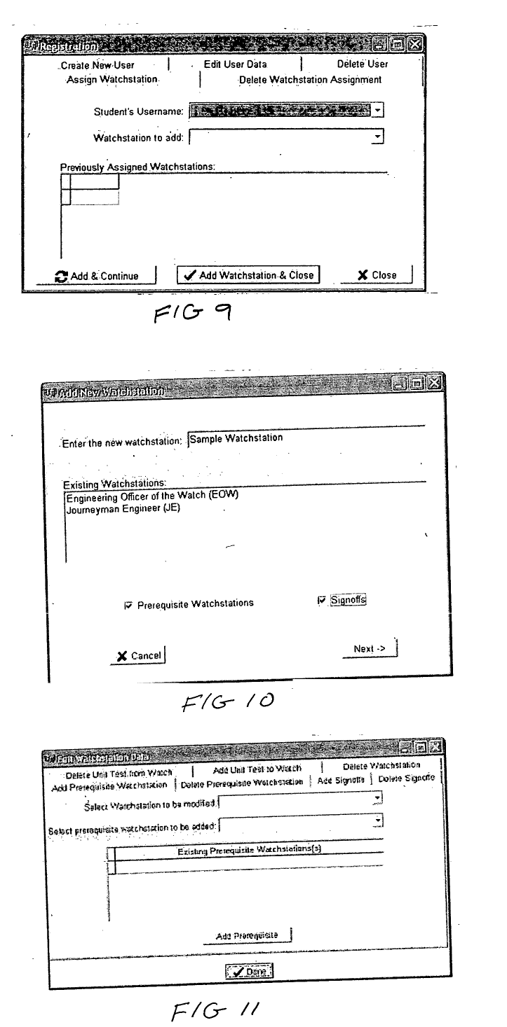

Referring to FIG. 1, an exemplary embodiment of the present invention is shown generally at 10. A trainee 12 receives comprehensive, standardized, self-study instructional material from a portable personnel computer (hereafter “PC”) 14, preferably a tablet PC, and specific watchstation performance requirements and procedures from a performance guide 16. The trainee periodically receives knowledge testing 18 from a centrally managed after the trainee completes a designated number of lessons. A database 22 maintains information to produce reports describing the trainees' progress and effectiveness of the training program. The performance guide and the Laptop PC administrate the trainee's on the job instruction 24.

Referring to FIG. 2, the tablet PC 14 is a portable computer having a screen 26 for input and output, microprocessor (not shown), memory devices (not shown), input and output ports 28 and a power source (not shown). In the exemplary preferred embodiment, the PC is a typical tablet PC, using the Tablet PC edition of Windows XP. In terms of functionality, the tablet PCs are interchangeable, and are available from a number of manufactures such as Viewsonic, Toshiba, Hewlett Packard, Acer, etc. A representative model would be the V1100 Tablet PC sold by Viewsonic. The Viewsonic V1100 Tablet PC utilizes a 866 Mhz Pentium IIIM processor and comes with 256 MB of RAM standard. The V1100 also comes equipped with a 20 MB hard drive as well as standard system interfaces such as USB and firewire. Data interfaces are also provided in the form of 802.11b wireless and RJ45 fast Ethernet data ports. The screen 26 consists of a display, typically a TFT, or liquid crystal display. Included with the screen is a graphic user interface for input.

Controls 30 are provided on the Tablet PC case. The controls on the Tablet PC hardware include the power button, the orientation button (used to switch between landscape/portrait display mode) as well as volume, keyboard and programmable function controls. The controls provide the capability to start up the tablet PC, to shut it down and to navigate through the graphical user interface. Generally navigation through the training modules will be by using a stylus with the graphical user interface. The graphical user interface also provides the capability to write notes on the screen and have the notes saved for future reference. In addition, an optional keyboard (not shown) and mouse (not shown) may be used for data entry and user navigation.

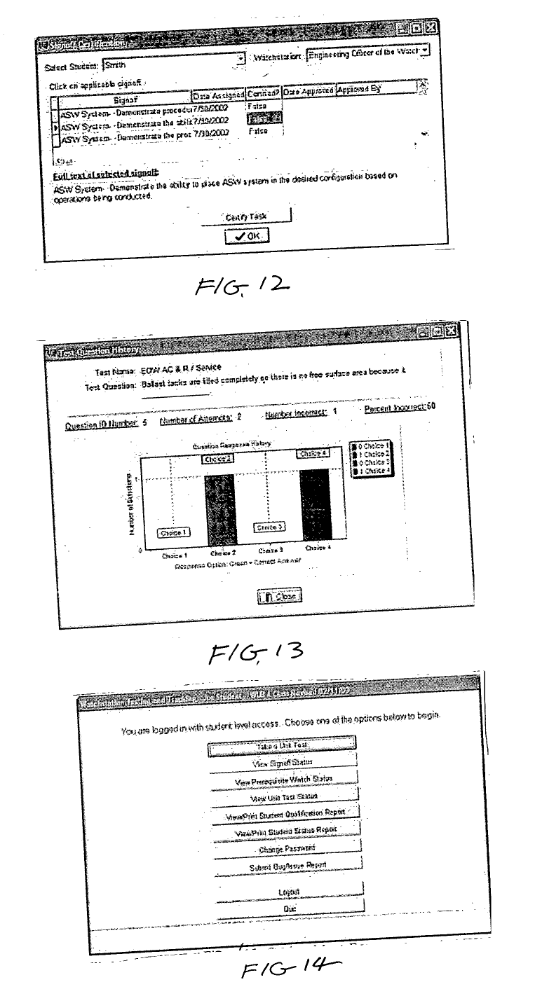

Referring to FIG. 3 a screen capture of a typical training module page that resides on the tablet PC is shown generally. The training module provides information to the watchstander during study. The tablet PC provides portability to train at the watchstation or other locations and provides maximum accessibility to training materials. The tablet PC includes the functionality to access different training modules through the use of indexes, book marks and hot links. The training materials may utilize technology associated with a program such as Adobe Acrobat, or may be presented in a web browser typically via HTML and/or java applets. In addition, any training related software that is designed to execute on a Windows based desktop PC or notebook will also be usable on a Tablet PC with little or no modification to the user interface. This software would include PC based simulations and interactive courseware (ICW).

Included within each training module is a list of learning objectives, figures or video demonstrations based upon the objectives, and a written description of information that is based upon the learning objectives. The written description provides all of the information necessary for the trainee to master the learning objectives. Written with reference to figures, the written description integrates visualization with description.

The Laptop PC is a typical commercially available PC capable of running version 1.0 of the Watchstation Testing and Tracking software (hereafter “WTT”) to be described hereinafter. To run the WTT, the PC must be running a Windows 98™ or higher operating system. Minimum system requirements are 32 MB of RAM and a 120 MHz Pentium processor or equivalent. Given these requirements, it is apparent that any notebook computers currently being manufactured are more than adequate (in terms of processing power and capacity) for running the WTT software. A CDROM drive or equivalent means, for example, an external memory device or Internet download capability is required for software installation. The PC contains a non-volatile memory storage device such as a hard disk, a microprocessor and input and output devices such as a mouse, or track pad. In addition, the notebook computer should preferably have USB ports available to facilitate the transfer of data to USB drives, as well as the connection of a printer for printing status reports. To accept the software and databases, a memory device, for example a hard disk, preferably should have a capacity of at least 100 MB of free hard drive space for program operation and data storage. However, the memory requirement may vary and depends upon the expected size of the database. As is well known in the art, memory can be selected to match the database or increased by installing a higher capacity disk drive.

In an exemplary embodiment, the Performance Guide is a hard copy booklet although in other embodiments the performance guide may reside on a PC. The use of a hard copy performance guide is preferable because of its low cost and other practical attributes such as weight, portability, durability and reliability. Since the performance guide is used at the watchstation over a long period of time, a booklet was chosen. In the exemplary embodiment, the performance guides are provided on the notebook computer and on CD in order to facilitate the printing of additional guides by the training location.

The performance guide provides detailed specific tasks required to be successfully completed by the trainee. The tasks include both knowledge testing and performance testing requirements. Generally, these requirements are to be demonstrated from memory at the applicable watchstation.

Referring to FIG. 4, the WQS flow chart, shown generally at 100, will now be described. WQS standardizes the qualification process by standardizing the design, development and evaluation process. The WQS process comprises eleven general steps that operate as a cycle that continuously identifies new performances, updates old performances and reevaluates the knowledge items and evaluation that support the new performances. A watchstation or job definition 102 is identified for application of the WQS process. Then, the specific tasks inherent in successful job performance are identified 104. To thoroughly capture the on-the-job requirements, details of each performance behavior are analyzed. The result of the analysis is an outline of specific performance procedures for the tasks of the job that establish a comprehensive job performance baseline.

After the on-the-job performance tasks have been defined, the knowledge items that support each performance task are identified 106. As is well known in the art of instructional system design, communication of knowledge necessary to perform critical tasks is integral to the delivery of successful training. Such critical tasks may, for example, include the steps necessary to start a pump without producing cavitation, runout, overcurrent or overpressure. Preferably, information is not included if it does not directly support performance tasks. In addition, other information, for example health, safety, security, emergency and similar information is assessed if the value of that information has a nexus or relationship to job performance.

Once the performance objectives and knowledge have been determined learning aid analysis is performed. In learning aid analysis, accomplished performers identify instances where learning could be enhanced through visual imagery. Accomplished performers are recognized experts currently performing the job or watchstation under consideration. Visual learning aids are developed such as photographs; graphics, audio clips, videos and animation to reinforce the learning material. The use of visual aids promotes independent and self-paced learning, thus accelerating the qualification process. Any tools or equipment involved in a performance task, process, or in evolutions that are germane to the job, must be visually captured with media that is beneficial to the job performance learning objectives.

Formatted digital templates 110, as described hereinabove, are next developed. The templates incorporate the form and function of the final training product. The templates map the performance objectives, knowledge items, and visual learning aids into an instructional design. The templates provide a structure that facilitates the ease of content development as well as ensuring that all of the objectives are covered.

Next, the templates are populated by accomplished performers and other subject matter experts 112, who use technical references, formal directives, available documentation and on-the-job experiences. The subject matter expert is a person who has extensive knowledge and experience with the specific job or watchstation under consideration, and generally has experience with similar watchstations and associated equipment.

In an exemplary form of the embodiment the draft training materials, embodied in the templates 112, are reviewed using an iterative consensus approach 114 among the experts. In the preferred form of the approach, a group of accomplished performers will resolve all differences through discussions that result in unanimous concurrence. In these scenarios, a unanimous consensus of experts currently performing the task at the highest level defines the performance requirements of the job or watch. The resulting training materials 116 generally will be a refinement of the initial templates.

Development of the WQS evaluation tools 118 begins after the final training materials have been completed. WQS evaluation tools include testing to measure a trainee's knowledge and hands-on assessment of the trainee's ability to perform each job task.

In the exemplary embodiment of the invention it is preferable that knowledge evaluation be in the form of multiple choice, matching, or true/false test questions because these forms of questions can be evaluated using computers, which minimizes administrative burden. When multiple-choice questions are used, the stem and correct answer are derived from the training materials and objectives from the training modules. Accomplished performers ensure that each question stem addresses material that is substantive to support job performance, and that distractors are not correct answers, but not obviously wrong answers either as is well known in the art of examining students. Trivial or unimportant facts should not be tested.

For every identified job performance, a standardized and detailed sequence of sub-tasks is developed. These detailed performance procedures are provided to the evaluator to ensure that the trainee is evaluated against the exact performance procedures exactly as they were learned. The precision, comprehensiveness, and consistency inherent in this approach results in a standardized WQS process.

After development is completed, the WQS is introduced into its intended operational environment at the local facility 120. Preferably, this indoctrination should reinforce buy-in from executives, managers, first-line supervisors, and new trainees. Trainees and training administrators are provided with the necessary training, training aids, and job performance aids to transition WQS from the developers to the initial users and then to follow-on users for the life of the training system.

Finally, the actual effectiveness of the training is evaluated 122. Feedback for the training system and any proposed or actual changes are systematically gathered and evaluated for merit. The feedback system is embedded in WTT. Any problems with questions, content, or program operation can be reported and is stored in a text file on the hard drive. This text file is sent electronically to the supporting activity where every issue is initially considered to be valid. Preferably, a consensus approach as described hereinabove will be used to validate discrepancies and proposal improvements. The result of the evaluation will be revised materials, which will replace a portion of or all of the original materials. This results in a training program that incorporates the best available information because WQS is a dynamic system, which facilitates systematic updates.

Watchstation Testing and Tracking

Referring to FIGS. 5A,B, C & D, The Watchstation Testing and Tracking software (WTT), shown generally at 200, will now be described. In the exemplary embodiment WTT is used to manage the watchstation qualification process. WTT administers, grades and records all testing required by the qualification process. Test, performance, and prerequisite watch requirements are captured automatically when a watchstation is assigned to a trainee. WTT's reporting capabilities provide reports that present the training status for an entire crew, individual watchstation or an individual trainee.

The WTT's logon procedures 202, 204 control the level of access a particular user has on the system. The level of access is determined at the time the user logs into the WTT. Typically, the login process requires the username or ID number as well as the associated password. The level of access is set at the time the particular user account is created.

Administrative level access is reserved for the training administrator or those who are accessing the WTT for managing the training system. Users with administrative level access have the ability to create, edit and delete user accounts, assign and edit watchstation assignments, indicate that performance and prerequisite requirements have been accepted or certified, and view reports on a crew level or for an individual trainee.

Users who have signed on with trainee level access have the ability to take unit tests and view their own training status via on screen or printed reports. Trainee level users have no access to crew or other trainee data, nor can they make or modify any assignments within the WTT. Software programs provide functionality to the administrative user and include trainee registration 206, watchstation assignment 208, signoff and prerequisite certification 210, manual watch certification 212, edit/create watchstation data 214, clear instructor flags 216, viewing test questions 218, qualification letter setup 220, bug/issue submittal 222, verification of test question integrity 224, checking trainee progress and prediction of time to qualify 226, and reports 228. In the exemplary preferred embodiment the WTT program (WTT.exe) provides the functionality described above while the backup of the WTT data is accomplished by the data backup software (DBBackup.exe).

The software programs provide functionality by accessing various databases, to provide the data to the programs. The databases included in the exemplary embodiment include: the current user database, performance task assignments database, prerequisite assignments database, qualification letter information database, registration database, setup information database, test assignments database, test data database, test responses database, unit specific test parameters database, watchstation assignments database, watchstation catalog database, watchstation list database, watchstation performance tasks database, watchstation prerequisite database.

As is well known in the art several other databases are included. Database cg3307 is used in the generation of the page 7 report and does not store any historical data. The Page 7 Report is a standard report generated on Coast Guard Administrative Remarks Form CG-3307, which documents a crewmember's watch qualification. DBWORK.ini is a support file for the database system and does not need to be mentioned, while Database_ID.txt is simply a text file used to maintain a change record of the database and help with the version control and identification.

The database files used in the exemplary embodiment are Paradox files. The Paradox database is used because it is a simple, reliable database suitable for use in stand alone operation that, due to the development environment used, is free from further licensing issues. If the WTT would be used in a large networked environment, the database would be changed from Paradox to better support that environment. It is to be appreciated that the database can be changed to better suit an operating environment without sacrificing the functionality of the WTT.

A file maintenance tool compresses data files into a single archive with the DbBackup.exe file. DbBackup.exe is an application with a graphical user interface capable of archiving files, restoring files, and configuring the default source directory for data files and target directory for archive files. It is accessible by selecting the WTT Data Backup icon positioned on the desktop. DbBackup.exe was developed using Microsoft Visual C++ version 6.0 and BigSpeed Zip DLL version 3.01 for compression routines (bszip.dll). The graphical interface embedded within DBBackup.exe provides configuration of the application parameters including source directory of data files, target directory of archive files, archive file prefix, and data file name pattern. As is well known in the art, a default configuration is provided for the foregoing files and saved in the file DbBkCfg.txt.

Limited WTT functionality is available when signed in at the trainee level. The functions are those required to qualify for assigned watchstations and to track training progress. The functions include unit testing, view signoff status, view prerequisite watch status, view unit test status, view/print trainee qualification report, view/print trainee status report, change password and bug/issue submittal.

Referring again to FIG. 5B, the operation when a student is the user type 204 will now be described. The WTT will compare the registration information and determine if the trainee is registered 230. If the trainee is not registered a communication will be sent to the Training Officer 232. If the trainee is registered then the trainee is provided access to Knowledge Testing 234 and Performance Testing 236 to be tested. After the trainee completes the tests then the trainee will either pass or not pass 238, 240 the tests. The trainee must retake the tests until the tests are passed. If the test is passed, WTT determines if watchstation co-requisites are satisfied 242. If co-requisites are not satisfied then the co-requisites must be completed 246. Once the co-requisites are all met the trainee is qualified for the watchstation 244.

The operation of WTT will now be described:

Administrator Operations

The operation provided for the administrator will now be described. The trainee registration provides for the creation of user accounts by providing user information and establishing a temporary password.

The watchstation assignment program links associated unit tests and prerequisite watchstations and signoffs to a trainee when the trainee is assigned a particular watchstation.

Referring again to FIG. 5B, in the signoff and prerequisite certification 210, when a trainee fulfills the requirements for a performance signoff, a user with administrative level access will select the applicable signoff for that trainee and certify that it has been completed. Prerequisite watchstations that are included in the WTT will be automatically marked as completed when the trainee qualifies for that prerequisite under the WTT. If the trainee qualified for the prerequisite watchstation outside of the WTT, the administrative level user may manually certify the prerequisite in a manner similar to the signoff in the certification process.

Manual watch certification 212 provides that if a trainee has previously qualified for a particular watchstation, that watchstation may be assigned to the trainee within the WTT and then manually certified as qualified.

In the edit/create watchstation data function 229 the administrative level user may make minor changes to an existing watchstation or create a new watchstation. A minor change is defined as a change to an existing watch or creation of a watch that utilizes the unit tests currently in the local database. A major change to a watch would be one that requires the generation of new tests. The test development capability is not part of the WTT. It is accomplished using other software. This functionality provides the means to add or delete information such as associated unit tests, signoffs, and prerequisite watchstations, in addition to deleting watchstations.

Clear instructor flags 216 provides that if a trainee fails a particular unit test for a predetermined number of times, for example 3, the WTT will set an instructor flag. The predetermined number of time is determined from the judgment and experience of the administrator. The Flag will prevent the trainee from attempting the particular unit test again, until a user with administrative level access clears the flag. Clearing the instructor flag will allow the trainee to attempt the test again.

Viewing Test Questions 218 enables the administrator to review the validity of a test question. The software generates a historical graphical depiction of the responses to the question for analysis. A block is provided to prevent further use of the question in testing at the discretion of the administrator.

Qualification letter setup 220 is an automated process for generating and printing letters that document trainee qualification. The administrator enters the name and address of the office signing the letter and text is automatically generated.

The reports generator 228 provides various reports from information drawn from the databases. Typical reports include a crew qualification report, crew status report, trainee qualification report, trainee status report and bug/issue submittal reports. Watchstation certification letters are also generated.

Referring to FIG. 6, login Screen appears after WTT is started. When installed, WTT is provided with all watchstations predefined and all databases enabled to generate all unit tests, signoffs and prerequisite watchstations.

Referring FIG. 7, the new user registration Screen is shown. Using the new user registration screen, the administrator will proceed to perform the initial setup of the software for the specific training environment at the facility. Initial setup requires establishing a new administrative level account. After an administrator is established new accounts may be created.

Now referring to FIG. 8, the editing user data screen is shown. Using the editing user data screen, the administrator may edit or delete user data. To maintain control and integrity, the creation, edit and delete functions may be performed only with administrative level access.

Referring to FIG. 9, the assigning watchstation screen is shown. Once the trainee accounts are established in the WTT, the desired watchstations are assigned to the individual trainees. Assigning a watchstation will automatically assign the associated unit tests, signoffs, and the prerequisites to the designated trainee. As illustrated, from this screen the administrator may also delete watchstation assignments.

Referring to FIG. 10, the create a new watchstation screen is shown. As described hereinabove, the administrative functionality includes the ability to add a new watchstation. A watchstation development wizard guides the administrator through the watchstation development process. The administrator creates a new watch station by entering the name of the new watchstation and then indicating if the watchstation will have prerequisite watchstations and signoffs associated with it. Placing a check mark in the corresponding boxes enables the association. All watchstations in the WTT include unit tests. Clicking “Next” provides access to add unit tests. The unit tests to be associated with the watchstation are chosen from a drop down list containing the population of unit tests within the test assignments database. It is to be appreciated that it is possible to have a watch defined without unit tests; i.e. it would be comprised of signoffs and possibly prerequisites only.

Each test is associated to the newly created watchstation by clicking on “Add Unit Test” (not shown). When all of the desired tests are associated with the new watchstation, the administrator clicks “Next” and the above-preselected prerequisite watchstations or signoffs selection menus are enabled. Selection is made by use of dropdown lists similar to the procedure for adding unit tests. When all selections have been made, the administrator clicks on “Finish” to complete the watchstation creation process.

Referring to FIG. 11, the edit watchstation data screen is shown. Anytime subsequent to the creation or existence of a watchstation, the administrator may choose to edit the watchstation data by selecting “Edit Watchstation.” The Edit Watchstation Data process menu driven with predefined lists populating the selection process similar to the processes for creating a watchstation described hereinabove.

Referring to FIG. 12, the administrative certification or decertification menu screen is shown. The administrative certification menu allows the administrator to certify or decertify signoffs, perquisite watchstations and watchstation assignments for trainee. A dropdown list provides selection of the trainee names. Next the particular watchstation for data association is selected from a dropdown list. Scrolling and then clicking on the signoff to be certified or decertified access the resulting signoff list. If the signoff is not certified, “Certify Task” will appear on the screen. If the signoff is certified, “Decertify Task” will appear on the screen. Clicking on the “Certify Task” or “Decertify Task” will cause execution of the selected task. It is to be understood that certification of prerequisite watchstations is normally accomplished automatically within the WTT. When a trainee qualifies within the WTT for a watchstation, any occurrence of the particular watchstations as a prerequisite will automatically be marked as certified. In the situation where a trainee has qualified for a perquisite outside of the WTT, the manual certification provides a means of accomplishing the association.

The view test questions option provides a means of viewing any test question as well as the associated choices. By highlighting the desired question, all related data might be viewed. The test name and question identification number identifies the questions. The correct answer is not shown unless “view correct answer” is selected. All information shown is read only—non editable. A question may be removed from the pool of available questions for testing by selecting “Block Question” check space. If a check appears in the check box, the question will not appear on a test. Selecting “View Question History” will display the test question history screen.

Referring to FIG. 13 the test question history screen is shown. The screen provides information related to the history of a particular question. The information includes the number of times each possible answer was chosen, the percent of incorrectly answered responses and other information for question analysis as is well known in the art. A visual means such as a graph, typically a bar graph, depicts the history of the test question with incorrect choices and correct shown with color code.

In order to provide administrative control and analysis of the watchstation qualification program at a facility, the administrator may use the WTT program to generate reports to provide information. The report generator within WTT.exe accesses the databases to generate predefined reports as is well known in the art. The administrator is able to plan the logistics of the facility's manning and training requirements by generating various reports: The crew qualification report provides the status of crewmembers that are qualified for the watchstation within the WTT.

The crew status report provides a summary of the training status of all students who are assigned to a particular watchstation. The student qualification report provides a listing of all watchstations for which a selected student is qualified. The student status report provides a status, for a particular student, of all watchstation training assigned to the student. The print certification letter produces a letter listing all of the watchstations for which a student has qualified. In addition, the program provides other reports documenting student performance and qualification as is well known in the art. A compilation of these reports is used to assess ship readiness. This assessment is based on how many people are currently qualified for each watch, and a prediction of how many will be qualified at any point in the future.

Trainee Operation

Referring to FIG. 14 the student menu form is shown. The student menu provides the trainee with a concise selection of options. Moving the cursor over a particular option will provide on-screen explanation for the option. The options include, taking a unit test, viewing signoff status, viewing perquisite watch status, viewing unit test status, viewing or printing student qualification report, viewing or printing the student status report, changing password, submitting a bug/issue report, logout and quit.

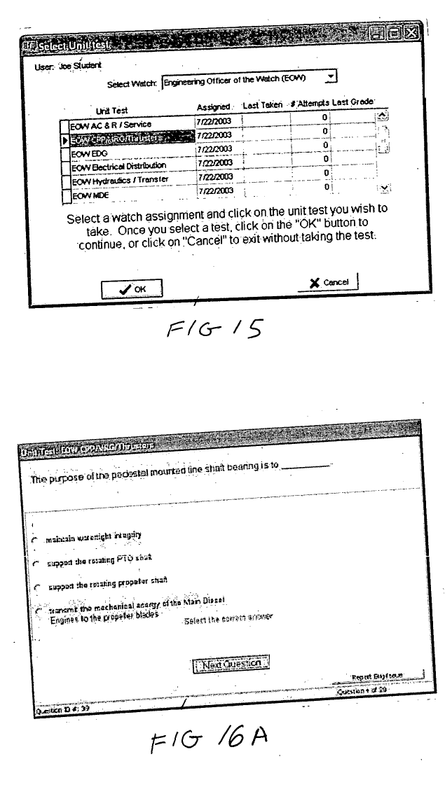

Referring to FIG. 15 the test selection form is shown. Selecting “Take a Unit Test” on the student menu picks the unit testing function. See FIG. 14. The WTT provides a means for the trainee to take multiple-choice tests related to the unit being studied. WTT includes a random question selection algorithm to randomly select questions from a bank of questions residing in the test data database, unit specific test parameters database and test assignments database. After selecting a test, a summary screen will appear. The summary screen provides the test name, number of questions, the minimum passing grade, as well as instructions regarding taking the test. When the trainee is ready to take the test, the trainee selects “Begin Test.”

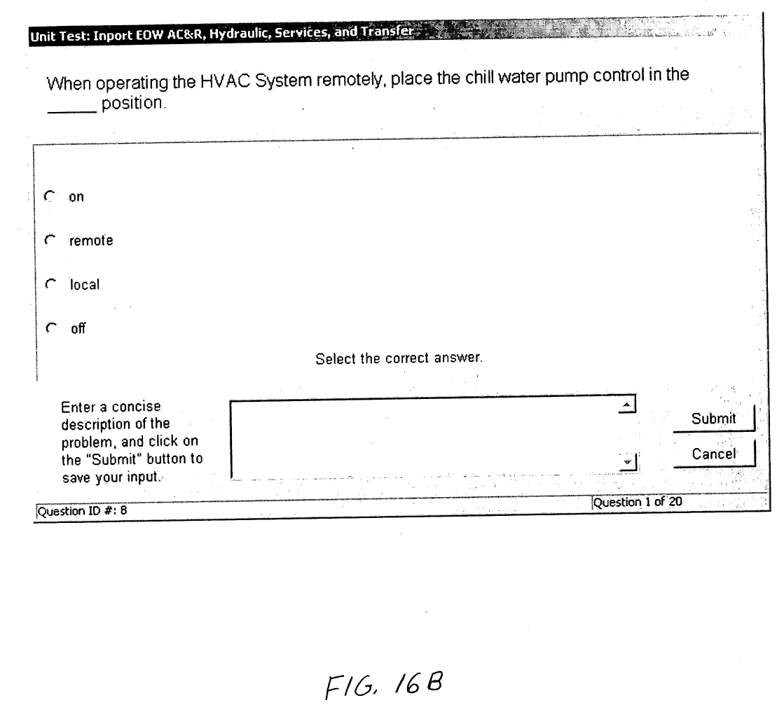

Referring to FIG. 16, a typical taking a unit test screen is shown. The trainee will select and click the radial button corresponding to the answer believed to be correct. After answer selection the trainee will proceed to the next question. If the trainee chooses to proceed to the next question without selecting an answer, the trainee will be alerted by a screen message, and the question will remain until an answer is selected. The lower left corner of the screen contains a question identification number The question identification number identifies the particular question within the database. On the lower right corner of the screen is the question count, which provides the student with an indication of progress through the test.

After testing as indicated by the trainee selecting “Complete Test,” the trainee will have the opportunity, prior to grading, to review his or her responses to make any changes to the answers or to grade the test without review. Reviewing the test provides the trainee with one opportunity to review his or her responses and make changes if desired. After review the test will be graded automatically and the results displayed with the trainee having access to correct answers for the questions he or she missed. Next, the grade is recorded being saved in the “Test Assignments T02.db” database.

At any time during the testing or review of the test, the bug/issues report generator will be enabled and accessible to the trainee for submission of bugs and issues. The bug/issue submittal provides the functionality for reporting bugs and issues for any issue relevant to WQS. The trainee may elect to submit a bug/issue by selecting the “Report Bug/Issue” icon on the bottom right corner of the screen. Referring to FIG. 16B, selecting the “Report Bug/Issue” icon will open a window at the bottom of the screen for the trainee to enter the concern related to a test question. Once finished, the trainee can save the information to a text file to be retrieved by a training administrator by selecting the “Submit” icon. The training administrator may elect to forward the information because it is in a form readily transmittable.

All bug/issue comments are stored in a text file named “BugList.txt.” This file is located in the “C:\WTTLocalData” folder. To view the file, Windows Explorer™ is opened and the folder is selected. To view the file select “BugList.txt” and Windows™ Notepad will open to display the contents of the file. To print the bug/issue reports, print the file from the Notepad menu.

Referring to FIG. 17, the view signoff status display is shown. In view signoff status the trainee views the signoffs that are assigned along with the status of the signoffs. The status indicators are certified and not certified.

View prerequisite status provides a report of all prerequisite watches assigned to the trainee as well as the status of the prerequisite watch (certified or not certified).

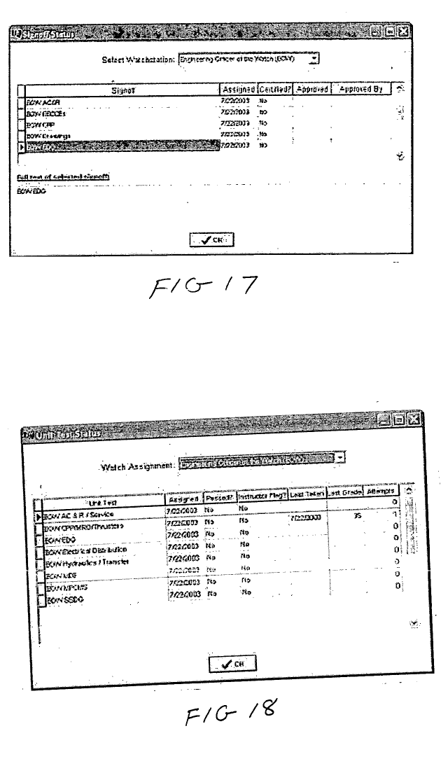

Referring to FIG. 18, the view unit test status is shown. The view unit test status provides the trainee with a list of all unit tests that are assigned to them, along with the following information: date assigned, passing status, instructor flag status, date last taken, last grade, and the number of attempts.

When the trainee account is created, a general password is provided. To maximize the security of the trainee's account, a trainee should change the password to one that does not follow a set pattern nor is easily determined by others. Selecting the “Change Password” Screen (not shown) and further selecting “Change Password” will change the prior password to a new password selected by the trainee. Such methods for changing a password are well known in the art

Several reports are available to provide the trainee with the status of his qualification. The view/print trainee qualification report gives the trainee an option to view and print a report of all watchstations for which they are qualified. The view/print trainee status report allows the trainee to view and print a report of all watchstation assignments and associated status information.

At the end of the session the trainee logs out of the system. Logging out prevents other personnel from accessing the trainee's data. In addition, the trainee may quit the WTT application by selecting the “Quit” icon. Quitting will automatically logout, close the trainee's account and shut down the WTT executable program. If the user has administrative access, the WTT execute program will be shutdown if “Administration” and “Exit” are selected.

As described, WQS is a portable, self-contained, standardized system for qualifying trainees for specific workstations, jobs, or teams within an organization. Every trainee pursuing a particular job is provided identical qualification materials and follows the same qualification process. Materials provided for qualification are comprehensive, directly relevant to the job, and presented in an instructionally sound format easily accessible from a single source. In addition to the standard training materials, WQS incorporates a standard evaluation process. Once qualified for a specific job, the qualification is readily recognized throughout the organization.

WQS provides maximum flexibility in terms of delivery media and technology configurations to align organizational training needs. As a self-contained system, WQS includes all the hardware, software, and information necessary to efficiently fulfill the qualification requirements and track the trainee's progress toward qualification. WQS includes training, training aids, and job performance aids to facilitate transition of the system from developer, to initial user, to follow-on users throughout the life cycle of the system.

While preferred embodiments have been shown and described, various modifications and substitutions may be made thereto without departing from the spirit and scope of the present invention. Accordingly, it is to be understood that the present invention has been described by way of illustrations and not limitation.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

What is claimed is:

1. A method for qualifying a trainee comprising:
performing a job task analysis
developing digital, standardized training modules after performing the job task analysis;
displaying the training modules on a first personal computer for self paced training of the trainee;
developing questions from the training modules and job performance requirements;
selecting questions from a bank of questions whereby the selection is random;
displaying the questions on a personal computer for testing the trainee;
grading the answers to the questions on a second personal computer;
analyzing the answers for determining further training;
determining whether the trainee has mastered knowledge required to perform a job based upon the trainee's responses;
providing standardized job task procedures defined by a performance guide; and
providing standard performance evaluation of the trainee by qualified supervisor.

2. The method of claim 1 wherein performing the job task analysis includes consensus from accomplished performers; and developing questions includes consensus from accomplished performers.

3. The method of claim 2 further comprising: introduction of the method into a local facility; evaluating the effectiveness of the method, and wherein the job task analysis includes defining the job and identifying performance tasks for implementation of the method at a local facility.

4. The method of claim 1 wherein the training modules, include pictures, the pictures defined from requirements of the job task analysis.

5. The method of claim 1 wherein the templates include video clips, the video clips defined from the requirements of the job task analysis.

6. The method of claim 1 wherein the requirements from the field comprise description data and location data.

7. The method of claim 1 wherein the first personal computer and the second personal computer are the same computer.

8. A method for qualifying a trainee comprising the steps of:
a. defining a watchstation
b. identifying performance for jobs at the watchstation
c. incorporating supporting knowledge for the performance steps
d. assessing visual learning aids for supporting knowledge for the performance steps
e. developing digital templates using the supporting knowledge and the visual learning aids
f. populating the digital templates using consensus from accomplished performers.
g. developing knowledge evaluation tools
h. providing the digital training modules and the evaluation tools at a local facility
i. evaluating the effectiveness of the defining step, identifying step, incorporating step, analyzing step, developing step, populating step, developing step and providing step for modification.

9. A system for qualifying a trainee to perform in a clearly defined watchstation comprising:
a. a first personal computer having training modules comprising instructional materials;
b. a second computer having administrative access for managing the training program and trainee access for testing on training material; and
c. a performance guide for guiding the trainee through the performance requirements of the watchstation, the performance guide defining the procedures for job task performances.

10. A computer program for managing a watchstation qualification program that has multiple trainees and multiple watchstations comprising:
a. an execution program for registering each trainee, assigning each trainee to each watchstation, signing off each trainee for prerequisite certification, performing manual watch certification, creating data for each watchstation, editing data for each watchstation, clearing instructor flags for each trainee, generating qualification letters, submitting bugs, verifying test question integrity, checking the progress of each trainee, predicting the time to qualification of each trainee; and
b. multiple databases comprising a current user database, a performance task assignments database, a prerequisite assignments database, a qualification letter information database, a registration database, a setup information database, a test assignments database, a test database, a test responses database, a unit specific test parameters database, a watchstation assignments database, a watchstation catalog database, a watchstation list database, a watchstation performance tasks database and a watchstation prerequisites database, the execution program accessing each of the multiple databases to perform functions of the execution program.

10. The computer program in claim 9 further comprising:
a. a database backup program for backing up each database of the multiple databases;
b. a compression of databases file for storing data from the database backup program;
